(19) United States
(12) Patent Application Publication
(10) Pub. No.: US 2003/0077356 A1
(43) Pub. Date: Apr. 24, 2003

(54) Shelf-stable sandwich and bread and method of making

(76) Inventors: Rosemarie Campbell, West Chicago, IL (US); Paul Vadevoulis, Glenview, IL (US)

Correspondence Address: JUDIE D. DZIEZAK, WALLENSTEIN & WAGNER, LTD., 311 SOUTH WACKER DRIVE, 53rd FLOOR, CHICAGO, IL, 60606-6630, US

(21) Appl. No.: 10/232,776

(22) Filed: Aug. 30, 2002

Related U.S. Application Data
(60) Provisional application No. 60/316,507, filed on Aug. 31, 2001.

(51) Int. Cl. A21D 2/00

(52) U.S. Cl. 426/20

(57) ABSTRACT

Provided is a bread product and a method of making the bread product having a shelf life of at least 60 days at ambient temperature and at least 6 months when stored frozen. Also provided is a sandwich having an extended shelf life, comprising two bread slices made according to the foregoing method, and a method of making the sandwich. The sandwich has a layer of a moisture-barrier substance disposed on one face of each bread slice, and at least one layer of a gelled food substance sandwiched between the barrier layers so as to separate the barrier layers from each other and form a sandwich having a shelf life of at least 45 days at ambient temperature and preferably 60 days at ambient temperature. In another aspect, the invention provides a nonmigrating, gelled filling suitable for use in the sandwich with the extended shelf life.

### TECHNICAL FIELD

This invention relates to breads and sandwiches and, more particularly, to a yeast-leavened bread and a sandwich made from such bread, both of which have an extended shelf life. The invention also relates to a method of making the bread and sandwich.

### CROSS REFERENCE TO RELATED APPLICATION

This application claims the benefit of U.S. Provisional Patent Application No. 60/316,507, filed Aug. 31, 2001.

### BACKGROUND OF INVENTION

Today's consumers seek convenience in foods, such as sandwiches. The shelf life of bread used in sandwiches is, however, typically short. For example, after about 10 days, when stored at ambient temperature, yeast-leavened bread loses its characteristic appealing flavor, aroma, and texture as it becomes stale and supports microbial growth. Moreover, from the time bread is used in a sandwich, its stability declines rapidly—in terms of both organoleptic and microbiological properties.

Various attempts have been made to develop bread and bakery products that have an extended shelf life.

Some efforts have focused on modifying the dough formulation through the addition of various ingredients. For example, U.S. Pat. No. 4,624,856 issued to Vanderveer et al. discloses the addition of humectants to doughs as a means of extending shelf life. This patent discloses a composition for a soft edible baked product having an improved extended shelf life and an edible firm gel blended into the dough. The gel is a dough conditioner made from an edible gum, an edible calcium salt, and a viscous liquid that acts as a humectant, which ingredients are admixed and then ground before being added to the dough prior to baking The particulates of ground gel impart soft eating qualities to the baked product.

U.S. Pat. No. 4,511,585 issued to Durst discloses ready-to-eat baked goods that are shelf stable for up to one year as a result of the addition of polyhydric alcohol. The addition of an edible liquid polyhydric alcohol such as glycerine to doughs containing high amounts of sugar—e.g., 10% or more sugar by weight of the finished product—controls the water activity of the dough and provides a long shelf life.

Enzymes have also been explored as means of retarding staling in baked goods. U.S. Pat. No. 5,209,938 issued to Kraus et al. discloses the addition of bacterial alpha-amylase enzymes having an optimum Phadebas activity above 100% to retard staling without causing a gummy texture or otherwise affecting the organoleptic characteristics of the goods.

The extended shelf of the compositions in the foregoing references is result of the addition of nonconventional ingredients—i.e., those that are not “traditionally” used in breads and baked products. Although Durst purportedly achieves a year-long shelf life, the reference does so in high-sugar baked products. The other references disclose only a slight increase in shelf life so that the breads made according to these references are not suitable for use in ready-made sandwiches where storage for weeks at a time is desired.

With respect to sandwiches, one problem typifying sandwich fillings is their tendency to migrate through the bread, causing discoloration and promoting microbial growth. In fact, the much beloved sandwich filler—jelly—is particularly problematic. In U.S. Pat. No. 5,567,454 and its continuation, U.S. Re37,275, Bogdan discloses a pre-formed nut butter and jelly slice, individually wrapped in a flexible covering and packaged in a food container for expediting sandwich preparation. The slice comprises a layer of nut butter wholly encapsulated between two layers of jelly, with a ridge of jelly enclosing the sides. Packaged to be used as needed, these slices are not intended to provide any extended shelf in a pre-made sandwich.

Shelf-stable sandwiches have been researched in the past. For example, U.S. Pat. No. 4,721,622 issued to Kingham et al. discloses a shelf-stable, filled snack food having a bread casing that wholly encloses a sterile filling. The sandwich is wrapped in a sterile, moisture-proof wrapping. The casing and enclosed filling are microbiologically unstable when devoid of the wrapping. The reference does not disclose any extensive shelf life at ambient temperatures.

Three patent applications directed to a sealed crustless sandwich are presently on file in the U.S. Patent and Trademark Office. These include U.S. 2001/0009685, 2001/0016221, and 2001/002532—all of which list Kretchman, et al. as the inventors. The sandwich comprises an upper filling such a peanut butter, a middle filling such as jelly, and a lower filling such as peanut butter, sandwiched between an upper bread portion and a lower bread portion. The perimeter of the sandwich is crimped so the upper and lower fillings join together at the point of crimping so as to encapsulate the middle jelly filling. The crust is removed from the sandwich and the sandwich is packaged in air-tight resilient packaging. This reference is directed at a sandwich concept and, as with the references listed above, does not disclose a product having an extended shelf life.

Thus, there exists a need for shelf stable sandwich materials—i.e., breads and fillings—along with a shelf stable sandwich The present invention address these needs and other problems.

### SUMMARY OF THE INVENTION

The present invention is directed to shelf stable breads, sandwich fillings, and sandwiches and methods of making shelf-stable breads and sandwiches. In one aspect, the present invention provides a medication delivery system for use in hospitals and healthcare facilities.

In one aspect, the present invention provides a method of making a shelf-stable bread product. The method comprises (a) feeding yeast with a sufficient quantity of flour and liquid under conditions sufficient to form a yeast feed, wherein the yeast comprises a blend of Saccharomyces and Bacillus species; (b) mixing the yeast feed with flour, sugar and liquid in sufficient quantities to form a mixture; (c) maintaining the mixture for a time and at a temperature and a relative humidity sufficient for the yeast to utilize nutrients present in the mixture; (d) forming a dough by adding, to the mixture, ingredients chosen from flour, sugar, egg, and fat; (e) shaping the resulting dough into a desired form; (f) proofing the shaped dough by heating the dough at an elevated temperature and relative humidity for a time sufficient for the dough to develop volume; (g) baking the dough at a temperature and for a time sufficient to yield a baked bread product; and (h) cooling the bread product to produce a bread having a shelf life of at least 60 days at ambient temperature.

In another aspect, the invention provides a bread product made according to the method described above.

In a third aspect, the invention provides a nonmigrating, gelled filling comprising a fruit juice, a starch and a hydrocolloid, wherein the starch and hydrocolloid are present in a ratio ranging from about 3:30 to about 1:10.

In a fourth aspect, the invention provides a shelf-stable sandwich comprising (a) a first bread slice and a second bread slice, each bread slice being made according to the method described above and having a facing surface, (b) a first barrier layer of a moisture-retarding substance being disposed on substantially the entire facing surface of said first bread slice; (c) a second barrier layer of said moisture-retarding substance being disposed on substantially the entire facing surface of said second bread slice, and (d) at least one layer of a gelled product having two opposed faces, one of said faces being in contact with the first barrier layer and the other of said faces being in contact with the second barrier layer so as to separate the barrier layers and form a sandwich having a shelf life of at least 45 days at ambient temperature.

In a fifth aspect, a shelf-stable sandwich is provided, comprising (a) a first slice of bread and a second slice of bread, said bread having a shelf life of at least 60 days at ambient temperature, (b) a layer of barrier material disposed on one surface of the first slice of bread and on one surface of the second slice of bread, and (c) a gelled food substance in contact with each layer of the barrier material so as to separate the layers from each other and form a sandwich having a shelf life of at least 45 days at ambient temperature.

Yet another aspect of the invention provides a method of making a shelf-stable sandwich. The method includes: (a) providing two slices of bread made according to the method of claim 8, each slice having an inner face and an outer edge; (b) applying a layer of barrier material onto the inner face of each of said bread slices in a quantity sufficient to cover a substantial portion of the inner face with a layer of said barrier material; (c) applying at least one layer of a gelled product onto a substantial portion of one layer of the barrier material; and (d) forming a shelf-stable sandwich by bringing the inner faces of the two slices of bread together so that the gelled product contacts the layers of barrier material on each of the two slices of bread layers so as to separate said layers and the form a sandwich having a shelf life of at least 45 days at ambient temperature.

### BRIEF DESCRIPTION OF THE DRAWINGS

FIG. 1 is a flow chart illustrating the steps employed in a method for making a shelf-stable bread product in accordance with the invention;

FIG. 2 is side perspective view of a loaf of the shelf-stable bread made in accordance with the invention;

FIG. 3 is a cross-sectional view of the bread loaf shown in FIG. 2, taken along line 2-2;

FIG. 4 is an upper perspective view of a sandwich according to the invention; and

FIG. 5 is a cross-sectional view of the sandwich shown in FIG. 2, taken along line 4-4.

### DETAILED DESCRIPTION

While this invention is susceptible of embodiment in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiments illustrated.

The present invention is directed to:

(a) a method of making a bread product having a shelf life of at least 60 days at ambient temperature and at least 6 months when stored frozen,

(b) a bread product made in accordance with such method,

(c) a nonmigrating, gelled filling suitable for use in a sandwich with an extended shelf life,

(d) a sandwich comprising two bread slices made according to the method described above and having a layer of a moisture-barrier substance disposed on one face of each bread slice, and at least one layer of a gelled food substance sandwiched between the barrier layers so as to separate them from each other and form a sandwich having a shelf life of at least 45 days at ambient temperature and preferably 60 days at ambient temperature; and

(e) a sandwich that is shelf stable for at least 45 days at ambient temperature, having two slices of a bread with a shelf life of at least 60 days at ambient temperature, two layers of a barrier material, one layer being disposed on one side of each of the two slices of bread, and a gelled food substance in contact with the two layers of the barrier material so as to separate the layers from each other and form a sandwich; and

(f) a method of making the shelf-stable sandwich.

Throughout this application, all references to “shelf life” of the bread and sandwich are based on storage at ambient temperatures, unless noted otherwise.

The term “ambient temperature” means a temperature ranging from about 19 to about 21 degrees C. (i.e., from about 65 to about 72 degrees F.).

The term “freezer temperature” means a temperature ranging from about 31.7 to about 34.4 degrees C. (i.e., from about 25 to about 30 degrees F.).

The term “refrigeration temperature” means a temperature ranging from about 2 to about 4 degrees C. (i.e., from about 35 to about 40 degrees F.).

The Bread Product and a Method of Making the Shelf-Stable Bread

The bread of this invention is substantially different from conventional “white” sandwich bread. Conventional white sandwich bread typically has a soft texture and is produced by a process that takes less than 5 hours, and typically 3 hours, from the time the ingredients are mixed until the bread is baked, cooled, and sliced. The conventional process is a straight dough method that generally involves mixing all the ingredients for about 25 minutes to form a dough, dividing and molding the dough into loaves, proofing the loaves for about 65 minutes at a temperature of about 37.7 degrees C. (100 degrees F.) and a relative humidity of about 85 percent, baking the loaves at a temperature of between 23 degrees C. and 32 degrees C. (i.e., between 75 degrees F. and 90 degreees F.) for about 43-46 minutes, cooling the baked bread for about 75-77 minutes, and finally, slicing and packaging the cooled product. The end result is a white, soft bread product, having a fairly uniform crumb structure characterized by tiny air cells—of substantially uniform size and shape—distributed throughout. Even when the dough is supplemented with dough conditioners and other shelf life-extending ingredients, the resulting bread product has a shelf life of less than 2 weeks at ambient temperature.

By contrast, the bread disclosed in this application uniquely has a shelf life of at least 60 days and preferably at least 90 days when stored at ambient temperature. When stored at freezing temperatures, the bread may have a shelf life of at least six months.

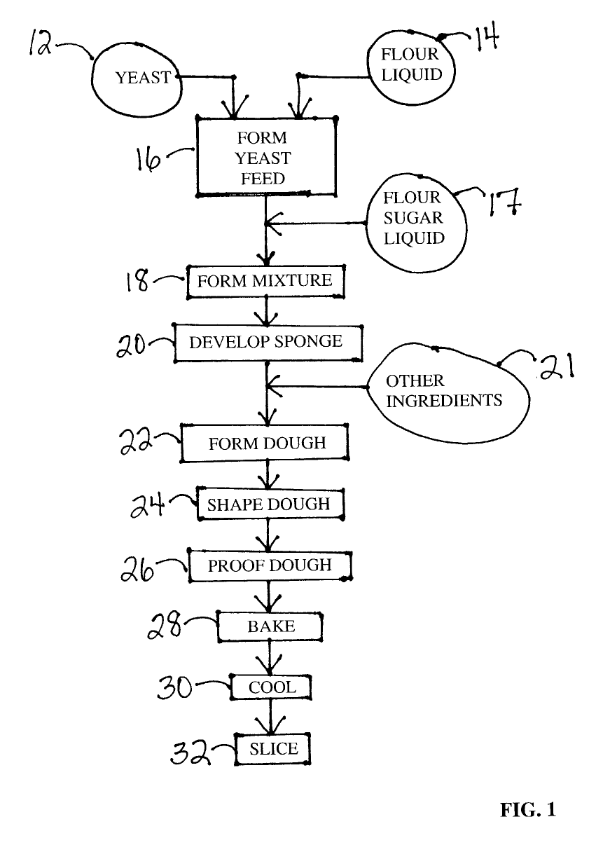

FIG. 1 depicts a flow chart illustrating one embodiment of a method for making a yeast-leavened bread having an extended shelf life in accordance with the invention.

The method may be used with virtually any bread dough formulation that comprises flour, yeast, and a liquid. The dough may comprise a variety of other conventional dough ingredients such as proteins (e.g., soy, gluten, dried milk, milk); sugars (e.g., sucrose, dextrose and sugar-containing foods such as honey); eggs (e.g., whole eggs, egg whites, egg yolks); and salt (e.g., sodium chloride, sodium sulfate, calcium sulfate, calcium acetate); fat (e.g., butter, margarine, shortening, granulated fat); and emulsifiers (e.g., mono- and diglycerides). Table 1 presents one example of a bread dough formulation that is suitable for use with the inventive method.

The yeast used is generally a form of Saccharomyces cerevisiae, known in the art as “Baker's yeast.” Typically, however, the yeast is a blend of Saccharomyces cerevisiae and selected Lactobacillus species. One example of a Lactobacillus species that is suitable for use in the method is L. sanfrancisco. The S. cerevisiae and Lactobacillus are initially combined at a ratio such that the S. cerevisiae predominates; e.g., the ratio of S. cerevisiae to Lactobacillus may range from about 2:1 to about 5:1.

TABLE 1
Example of a bread dough formulation.

| Ingredient | Weight Percent of Dough (%) |
|---|---|
| Bread flour | 45.96 |
| Water | 30.25 |
| Sugar | 10.88 |
| Fat | 11.55 |
| Egg | 0.75 |
| Salt | 0.22 |
| Yeast | 0.39 |

FIG. 1 shows a method 10 for making a shelf-stable bread in accordance with the invention. Each phase of the method is conducted at a temperature and relative humidity that would have an impact on the properties of the finished product.

Throughout the method, the various stages are practiced under sterile conditions.

The method begins with feeding the yeast 12 with a sufficient quantity of flour and liquid (collectively shown by reference number 14) under conditions sufficient to form a yeast feed 16, also known as a “Madre.” The yeast feed is fed continuously with flour and water in amounts sufficient to maintain the pH in a range of from about 3.5 to about 5.0 and preferably from about 3.7 to about 4.6. The yeast feed is typically fed for at least 3 hours—preferably from about 3 to about 24 hours, and more preferably from about 8 to about 18 hours. Throughout this phase, the pH of the yeast feed is monitored. Generally, the yeast feed is ready for use when it has a consistent pH range of from about 3.8 to about 5.0 The temperature of the yeast feed during this process generally ranges from about 10 to about 18 degrees Centigrade (i.e., from about 50 to about 65 degrees F.). A range of relative humidities may be used in this phase. The relative humidity ultimately selected depends upon the properties desired in the finished baked product. Further discussion on relative humidity of this phase is not included, because the optimum relative humidity may be readily determined by one skilled in the art.

The yeast feed is then blended with a portion of the flour, sugar and liquid from the formulation, shown by reference number 17, in sufficient quantities to form a mixture, shown by reference number 18 in FIG. 1. Typically, about three-quarters of the liquid and flour, preferably bread flour, are used to form the mixture. The pH of the mixture ranges from about to about 4.2 to about 5.6.

A sponge is then formed from the mixture, as shown by reference number 20, by maintaining the mixture for a time and at a temperature and a relative humidity sufficient for the yeast to utilize nutrients present in the mixture. The sponge-forming step takes for from about 2 to about 24 hours, preferably from about 8 to about 18 hours, and more preferably from about 12 to about 14 hours. The pH of the sponge generally ranges from 3.7 to about 5.0 and preferably from about 3.8 to about 4.7. The temperature of the sponge generally ranges from about 23 to about 32 degrees C. (i.e., from about 70 to about 90 degrees F.), and the relative humidity ranges from about 75 to about 90 percent.

In an alternative embodiment, sponge formation may be expedited by the addition of fermentation additives, which replicate the end products of fermentation. Because such additives are widely known to those skilled in the art, they are not discussed herein.

After a suitable sponge has been formed, other ingredients (shown by reference number 21) are added to form a dough, as shown by reference number 22. Such ingredients include the remaining flour and liquid, including sugar(s), egg or egg-derivative products, fat, and other ingredients that serve primarily as flavorants, such as nuts, flavors, chocolate, and fruits.

The resulting dough is then shaped as desired, as shown by reference number 24. For example, the dough may have a variety of cross-sectional shapes such as round, oblong, elliptical, and polygonal with at least 3 sides (such as a triangle, rectangle, square, and octagon). The cross-sectional shape of the dough is not restricted by this method.

The next step is proofing the dough, which is depicted in FIG. 1 by reference number 26. Proofing is conducted by heating the dough at an elevated temperature and a relative humidity for a time sufficient for the yeast to aerobically ferment the sugars. Carbon dioxide evolved during fermentation produces air cells in the dough, adding volume. Proofing is done at a temperature ranging from about 15 to about 32 degrees C. (i.e., from about 60 to about 90 degrees F.), and preferably from about 18 to about 29 degrees C. (i.e., from about 65 to about 85 degrees F.), and a relative humidity ranging from about 65 to 80 percent, and preferably from about 70 to 75 percent.

After the proofing step, the dough is baked at a temperature and for a time sufficient to yield a baked bread product. FIG. 1 shows this step as reference number 28. The baking temperatures are generally known to those skilled in the art. For example, typically, the baking temperatures range from about 170 to about 235 degrees C. (i.e., about 338 to about 455 degrees F.), and preferably from about 195 to about 225 degrees C. (i.e., about 384 to about 435 degrees F.). The baking temperature may be modified as needed, per the formulation and volume of dough. The baking time will depend upon the composition of the dough, the shape of the dough, and the volume of dough being baked, and may readily be determined by one skilled in the art.

The baked bread is next cooled to prepare it for packaging. Shown by reference number 30, cooling is conducted for a time and a temperature sufficient to reduce the internal temperature of the bread to less than 23 degrees C. (i.e., 73 degrees F.), and preferably below about 25 degrees C. (i.e., about 77 degrees F.). Typically, the cooling temperature ranges from about 18 to about 23 degrees C. (i.e., from about 65 to about 75 degrees F.), as known by those skilled in the art.

In one embodiment, the bread is cut into slices of a predetermined thickness, as shown by reference number 32. Typically, the thickness is at least 0.25 inches and preferably ranges from about 0.25 to about 0.75 inches. The baked and cooled bread has a pH ranging from about 3.6 to about 4.8, and preferably from about 3.9 to about 4.3. Because of the pH and the constituents that develop in the dough and bread as a result of this method, the bread exhibits an outstanding shelf stability.

The bread is the usually packaged, with at least one slice sealed in suitable packaging wrap material; e.g., a polymeric packaging such as poly propylene.

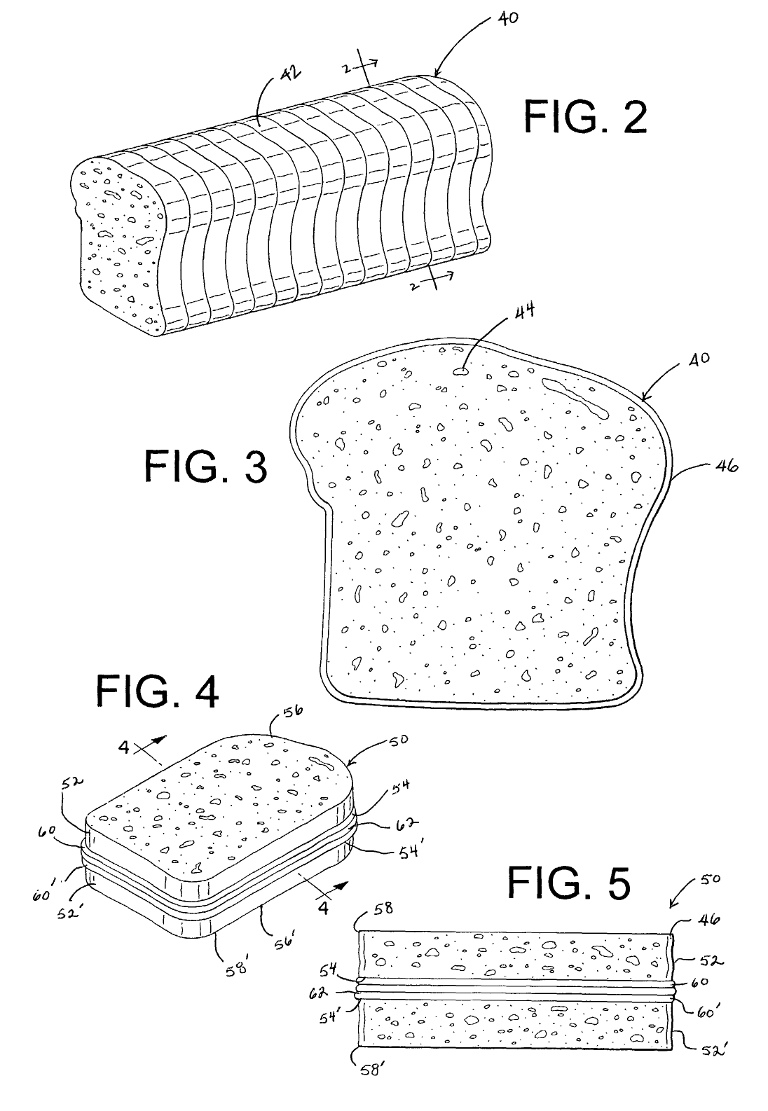

FIG. 2 is side perspective view of a loaf of the bread 40 made in accordance with the inventive method. The bread 40 is typically cut cross-wise into relatively uniform slices 42.

FIG. 3 is a cross-sectional view of the bread loaf shown in FIG. 2. Throughout the bread are numerous air cells 44, generally of various sizes and shapes. The air cells may, e.g., range from elliptical, oblong, or round to any other shape, or they may be amorphous in configuration. Typically, the bread 40 has golden crust 46.

The bread has a firm texture, preferably firmer than that of conventional white sandwich bread. In one embodiment, the bread has an “enriched” appearance as a result of a formulation.

The Shelf-Stable Sandwich and a Method of Making

In another aspect of the invention, a shelf-stable sandwich is provided. Various embodiments are contemplated.

FIG. 4 shows one embodiment of a sandwich 50 made in accordance with the method described above.

FIG. 5 shows a cross-sectional view of the sandwich 50 shown in FIG. 4.

The sandwich 50 comprises two layers 52—also termed “slices”—of the bread 40. Each layer 52, 52′ has an inner face 54, 54′, an outer face 56, 56′ and an outer edge 58, 58′ The inner faces 54, 54′ of the two layers 52, 52′ face each other. A barrier layer 60, 60′ is disposed on substantially the entire inner face 54, 54′ of each of the first bread layer 52 and the second bread layer 52′. The barrier layers 60, 60′ typically extend to the outer edge 58, 58′ of the bread layers 52, 52′. Sandwiched between the barrier layers 52, 52′ is at least one layer of a gelled food substance 62. The sandwich 50 shown in FIG. 4 shows one layer of the gelled food substance 62. The gelled product 62 extends substantially across the entire surface of the barrier layers 52, 52′ and preferably to at least the outer edge 58, 58′ of the bread layer 52, 52′ so to separate the barrier layers 52, 52′ from each other. The resulting sandwich has a shelf life of at least 45 days and preferably at least 60 days under ambient temperature.

The barrier layer 52, 52′ is a layer of a moisture-retarding material, as it prevents moisture present in the gelled product 62 from migrating into the bread layers 52, 52′, causing an unaesthetic appearance and promoting microbial growth. Although the barrier layers 52, 52′ are typically peanut butter, they may be a chocolate or chocolate-containing spread or other spread made from nuts, nut butters, dehydrated fruits, or dehydrated vegetables, as examples.

Generally, the barrier layers 52, 52′ are of the same material; however, in one embodiment, the barrier layers 52, 52′ comprise different materials.

The layer of gelled food substance 62 is a nonmigrating gelled filling that typically comprises a hydrocolloid and starch, along with other materials, for texture. In one embodiment, the gelled food substance 62 is a jelly comprising at least one of fruit solids, and fruit juice which contains fruit solid. The gelled food substance 62 is a blend of starch and hydrocolloids; however, the gelled food substance 62 may be virtually any suitable gelled food substance such as jam, preserves, or other products. The gelled filling has a pH ranging from about 3 to about 6, and a water activity ranging from about 0.8 to about 0.9.

A variety of starches may be used in gelled food substances, such as corn starch, modified corn starch, and maltodextrin. Examples of suitable hydrocolloids include xanthan, guar gum, alginate, carrageenan, and locust bean gum. Generally, the starch and hydrocolloid are present in the gelled food substance 62 in a ratio of starch-to-hydrocolloid ranging from about 1:30 to about 1:10. The total concentration of the starch and hydrocolloid blend ranges from about 0.05 to about 0.25% of the total wet weight of the formulation.

The layer of the gelled substance has a dimension substantially corresponding to that of the bread. More particularly, the gelled product is applied so as to extend to at least an outer edge of each of the bread slices.

Various methods are contemplated for making the inventive sandwich 50. In one embodiment, the method comprises disposing a barrier material 60, 60′ onto the inner face 54, 54′ of each of two bread slices 52, 52′ made in accordance with the invention. The barrier material 60, 60′ is disposed in a quantity sufficient to cover a substantial portion of the inner face. The barrier material 60, 60′ is then spread onto a substantial portion of the inner face 54, 54″ and preferably, the entire surface of the inner face 54, 54′. At least one layer of gelled food substance 62 is applied onto a substantial portion of one layer of the barrier material 60, 60′. Preferably, the gelled food substance 62 is applied so it extends across the entire surface of the barrier material layer 60, 60′. Preferably, the gelled food substance 62 is spread so it extends to at least the outer edge 58, 58′ of the bread sliced layer 52, 52′. The bread slices 52, 52′ are then brought together, so as to sandwich the gelled food substance 62 between the two barrier material layers 60, 60′ and preferably so that the gelled food substance 62 separates the barrier layers 60, 60′, creating distinct layers.

The sandwich has a shelf life of at least 45 days and preferably at least 60 days when stored at ambient temperature, which makes it most convenient for today's busy consumers. When stored at freezing temperatures, the sandwich may have a shelf life of at least four months.

The sandwich is generally packaged in a wrap such as polymeric fmaterial, e.g., polypropylene.

While this invention may be embodied in many different forms, the drawings and following description detail preferred embodiments of the invention with the understanding that the present disclosure is to be considered as an exemplification of the principles of the invention and is not intended to limit the broad aspect of the invention to the embodiments illustrated.

While the specific embodiments have been illustrated and described, numerous modifications come to mind without significantly departing from the spirit of the invention and the scope of protection is only limited by the scope of the accompanying claims.

We claim:

1. A method of making a shelf-stable bread product, comprising the steps of:
(a) feeding yeast comprising a blend of Saccharomyces and Lactobacillus species with a sufficient quantity of flour and a liquid under conditions sufficient to form a yeast feed;
(b) mixing the yeast feed with flour, sugar and a liquid in sufficient quantities to form a mixture;
(c) maintaining the mixture for a time and at a temperature and a relative humidity sufficient for the yeast to utilize nutrients present in the mixture;
(d) forming a dough by adding, to the mixture, ingredients chosen from flour, sugar, egg, and fat;
(e) shaping the resulting dough into a desired form;
(f) proofing the shaped dough by heating the dough at an elevated temperature and relative humidity for a time sufficient for the dough to develop volume;
(g) baking the dough at a temperature and for a time sufficient to yield a baked bread product; and
(h) cooling the bread product to produce a bread having a shelf life of at least 60 days at ambient temperature.

2. The method of claim 1 wherein in step (a), the Saccharomyces and Lactobacillus species are present in a ratio of Saccharomyces to Lactobacillus ranging from 2:1 to 5:1.

3. The method of claim 1 wherein step (a) comprises maintaining the yeast feed in a pH ranging from about 3.5 to about 5.0.

4. The method of claim 1 wherein step (a) is conducted at a temperature ranging from about 10 to about 18 degrees Centigrade (i.e., from about 50 to about 65 degrees F.).

5. The method of claim 1 wherein step (a) is conducted for from about 3 hours to about 24 hours.

6. The method of claim 1 wherein the sponge-forming step is conducted for from 2 to 24 hours.

7. The method of claim 1 wherein the pH of the sponge ranges from about 3.7 to about 5.0.

8. The method of claim 1 further comprising slicing the bread into slices having a predetermined thickness.

9. The method of claim 8 wherein the predetermined thickness ranges from about 0.25 inches to about 0.75 inches.

10. A bread product made according to the method of claim 1.

11. A bread product made according to the method of claim 8.

12. The bread product of claim 11 having a shelf life of at least 90 days at ambient temperature.

13. The bread product of claim 11 having a shelf life of at least 6 months when stored at freezer temperatures.

14. The bread product of claim 12 wherein the bread has a pH of from 3.6 to about 4.8.

15. The bread product of claim 12 having a pH ranging from about 3.9 to about 4.3.

16. The bread product of claim 10 wherein the bread has a cross-sectional shape selected from the group consisting of round, oblong, elliptical, and polygonal with at least 3 sides.

17. The bread product of claim 10 wherein the at least one slice of the bread is packaged in a wrap.

18. A nonmigrating, gelled filling comprising at least one of a fruit juice and fruit solids along with a starch and a hydrocolloid, wherein the starch and hydrocolloid are present in a starch-to-hydrocolloid ratio ranging from about 1:30 to about 1:10.

19. The gelled filling of claim 18 having a pH ranging from about t 3 to about 6.

20. The gelled filling of claim 18 having a water activity ranging from about 0.8 to about 0.9.

21. A shelf-stable sandwich comprising:
a first bread slice and a second bread slice, each said bread slice being made according to the method of claim 8 and having a facing surface,
a first barrier layer of a moisture-retarding substance being disposed on substantially the entire facing surface of said first bread slice; slice,
a second barrier layer of said moisture-retarding substance being disposed on substantially the entire facing surface of said second bread slice, and
at least one layer of a gelled product having two opposed faces, one of said faces being in contact with the first barrier layer and the other of said faces being in contact with the second barrier layer so as to separate the barrier layers and form a sandwich having a shelf life of at least 45 days at ambient temperature.

22. The sandwich of claim 21 wherein the sandwich has a shelf life of at least 60 days at ambient temperature.

23. The sandwich of claim 21 wherein the barrier substance is peanut butter.

24. The sandwich of claim 23 wherein the gelled food substance comprises a starch and a hydrocolloid and at least one of fruit juice and fruit solids.

25. The sandwich of claim 21 wherein the gelled food substance is a fruit jelly.

26. The sandwich of claim 21 wherein the layer of the gelled food substance has a dimension substantially corresponding to a dimension of the bread slices.

27. A shelf-stable sandwich comprising:
a first slice of bread and a second slice of bread, said bread having a shelf life of at least 60 days at ambient temperature,
a layer of barrier material disposed on one surface of the first slice of bread and on one surface of the second slice of bread, and
a gelled food substance in contact with each layer of the barrier material so as to separate the layers from each other and form a sandwich having a shelf life of at least 45 days at ambient temperature.

28. A method of making a shelf-stable sandwich comprising:
(a) providing two slices of bread made according to the method of claim 8, each slice having an inner face and an outer edge;
(b) applying a layer of barrier material onto the inner face of each of said bread slices in a quantity sufficient to cover a substantial portion of the inner face with a layer of said barrier material;
(c) applying at least one layer of a gelled product onto a substantial portion of one layer of the barrier material; and
(d) forming a shelf-stable sandwich by bringing the inner faces of the two slices of bread together so that the gelled product contacts the layers of barrier material on each of the two slices of bread layers so as to separate said layers and the form a sandwich having a shelf life of at least 45 days at ambient temperature.

29. The method of claim 28 wherein the gelled product is applied so as to extend to at least an outer edge of each of said bread slices.

30. The method of claim 28 wherein the barrier material comprises a nut butter.

31. The method of claim 30 wherein the gelled food substance comprises fruit solids.
